(19) United States
(12) Patent Application Publication
(10) Pub. No.: US 2013/0025545 A1
(43) Pub. Date: Jan. 31, 2013

(54) PET WASHING APPARATUS AND METHOD

(71) Applicants: Anibal Munoz, Homestead, FL (US); Nicole Cover-Munoz, Homestead, FL (US)

(72) Inventors: Anibal Munoz, Homestead, FL (US); Nicole Cover-Munoz, Homestead, FL (US)

(21) Appl. No.: 13/191,092

(22) Filed: Jul. 26, 2011

(51) Int. Cl. A01K 15/04; A01K 13/00

(52) U.S. Cl. 119/756

(57) ABSTRACT

A device and method for washing animals, particularly cats, including a frame assembly, a cover assembly and a harness assembly. Said frame assembly configured to support the weight of the animal being washed over a container of water. Said frame assembly supportable by the container and/or optional legs. Said frame assembly wrapped by the optional, durable cover. The device is utilized to wash an animal by restraining the animal in said harness assembly and attaching said harness assembly to said frame assembly. When the animal is restrained on the frame assembly over water the animal becomes docile and able to be easily washed.

### BACKGROUND OF THE INVENTION

1. Field of the Invention

The present invention relates to household pets, and more particularly, to a device and method to aid in the maintenance and cleaning of cats.

2. Description of the Related Art

Several designs for animal washing devices have been designed in the past. None of them, however, include a raised platform that supports and loosely restrains a feline without unduly stressing the animal and permitting a gentle cleaning.

All known means for cat cleaning generally fall into categories that can be fairly described as brushes/combs, moistened wipes, rubbing posts, cage-based and restraint devices. Each of these classes of devices has significant drawbacks to both the pet and their caretaker.

Brushes and combs are typically “dry” cleaning methods that tend to work best for collecting loose fur and the occasional fur-entangled debris. Odors and more resilient soiling are not effectively removed by brushing and combing. Additionally, this type of cleaning requires significant cat cooperation which cannot be relied upon through a thorough cleaning regimen.

Moistened wipes are a relatively recent class of cat and pet cleaning products that again require a cooperative cat. Wipes also contain chemicals and compounds that remain on the fur of the animal potentially causing irritation to skin of both the animal and the owner. Use of the wipe-style cleaner also fails to provide a thorough, skin deep cleaning of dander, hair, and other foreign substances.

Rubbing posts and other purpose build structures that a cat can rub against are only minimally effective. These devices can only work when the cat decides to use them and provide only the most basic removal of some shedding fur. Deep cleaning and removal of more stubborn foreign substances cannot effectively occur without penetrating the coat with a means to dissolve those foreign substances.

A commonly used, but questionably humane, method of feline cleaning essentially requires sequestration of the feline in a small cage-like device into which a cleaning solution is injected under pressure. Although it can be effective at cleaning the animal, this automatic-dishwasher-type device can cause significant stress.

Waterless shampoo and cleaning sprays tend to simply mask odors. The solutions remain on the fur and skin of the pet and can cause irritation to sensitive skin. Also, without rinsing the fur any foreign objects or contaminants are not removed from the fur.

Other known devices and patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a device and method to effectively clean cats.

It is another object of this invention to provide a water rinsed method for deep cleaning of a pet's fur.

It is still another object of the present invention to provide a safe and humane method to clean felines.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a perspective view of a principal variation of the assembled device.

FIG. 2 shows an exploded perspective view of the several components of a version of the device.

FIG. 3 illustrates a perspective view of the bottom side of an embodiment of the device with the cover assembly 12 removed.

FIG. 4 is a representation of a perspective view of a preferred variation of the device.

FIG. 5 shows a perspective view of a version of the device configured for use with a cat.

### DETAILED DESCRIPTION OF THE PREFERRED EMBODIMENT

Referring now to the drawings, where the present invention is generally referred to in FIG. 1 with numeral 10. It can be observed that it basically includes a cover assembly 12 and a frame assembly 14. A series of cleats 28 are also shown and identified on FIG. 1.

FIG. 2 shows the various component elements of a version of the invention to further include a pair of fasteners 16, a cover 18, a series of apertures 20, a pair of covers 22, a frame 24, an extension 26, a series of cleats 28, a flange 30 and a flange 32.

The main components of this version of the device are exploded for better understanding of the cover assembly 12 and the frame assembly 14. Note that the cover assembly 12 is inverted in relation to its normal interface with the frame assembly 14 to demonstrate the pair of fasteners 16 on the cover assembly 12.

Still referring to FIG. 2, the frame assembly 14 has two main components: the frame 24 and the extension 26. In this figure they are shown apart for illustrative purposes. In normal use the frame 24 and extension 26 are joined. The extension 26 has a smaller cross-section so that it can telescopically engage into the underside of the frame 24. The flanges 30 on either edge of the frame 24, in combination with the flanges 32 on either edge of the extension, aid in holding the extension 26 into the frame 24 and yet still allow them to move axially relative to one another. This axial movement essentially allows the overall combined length of the frame 24 and extension 26 to be adjusted as desired. In an important variation of the invention the frame 24 and extension 26 are friction fit together to hold these two elements together at a fixed length. The degree of friction is preset so that a user of the device can easily change the length but it will not inadvertently shorten or lengthen in normal use while cleaning a cat.

In a preferred construction, the frame 24 and extension 26 are made of a rigid and durable material such as plastic or metal. The frame assembly 14 must be able to support the weight of a feline or other animal to be washed. It is also preferably impervious to water and other solutions used in the bathing of animals.

A variation of the device may omit the extension 26 and the remaining frame 24 is thus fixed in length. The frame 24 may then be supplied to the end user at the predetermined length for a particular application.

Covers 22 are placed on each end of the frame assembly 14, one each on the frame 24 and extension 26. The covers 22 are preferably made of a durable and pliable material such as plastic or rubber. The covers 22 provide a degree of grip and cushioning between the frame assembly 14 and, for example, a bath tub or wash basin to prevent unwanted slippage or damage.

The cover 18 serves as a contact surface for the animal being washed and therefore should provide some degree of paw traction to the animal. The cover 18 is preferably a soft, resilient and flexible material such as fabric, sponge, carpet, rubber or similar material. Ideally, the cover 18 is odor and stain resistant and dries quickly.

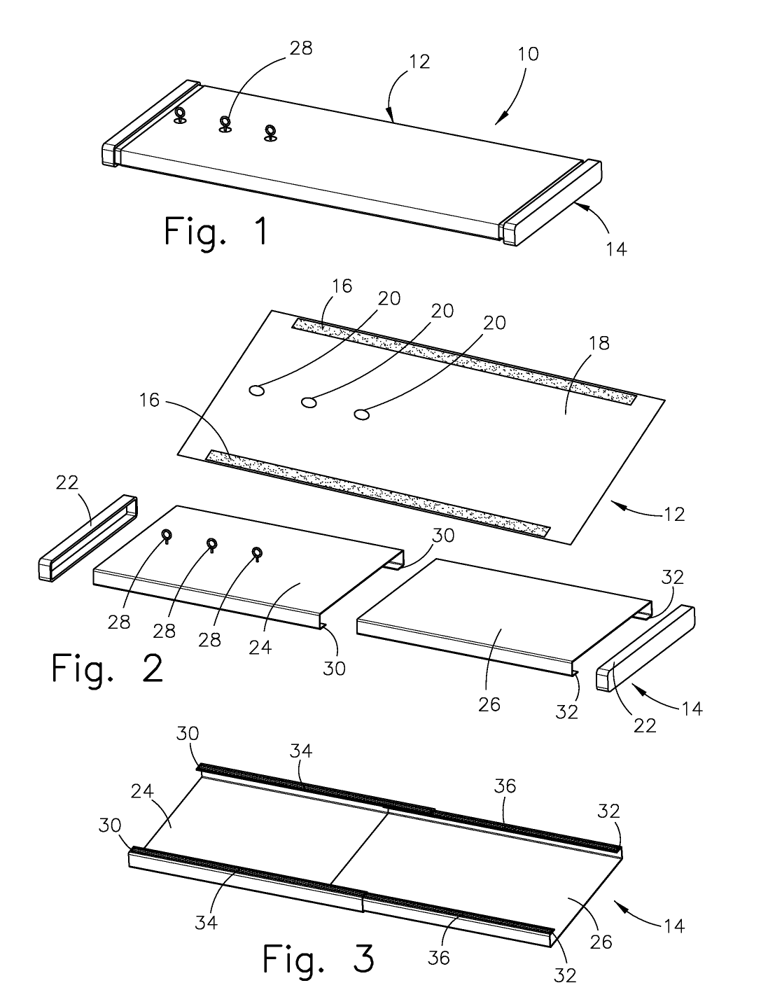

In use, the cover assembly 12 wraps around the top and edges of the frame assembly 14. The cover assembly 12 is attached to the frame assembly 14 by attaching fasteners 16 on the cover assembly 12 to the fasteners 34 and fasteners 36 (shown in FIG. 3). In a preferred configuration, fasteners 16 are one half of a set of a complimentary hook and loop fasteners configured to mate with the corresponding set comprising the fasteners 34 and fasteners 36. By this means the cover assembly 12 can be removably affixed to the frame assembly 14.

Notice that the cover assembly 12 is absent in the view shown in FIG. 3. In the example of the invention shown in FIGS. 2 and 3 it can be seen that the fasteners 16 span over both the corresponding fasteners 34 and fasteners 36 to further aid in affixing the frame 24 relative to the extension 26. In other words, when the frame 24 and extension 26 are engaged into each other to the preferred degree then the cover assembly 12 is wrapped around the frame assembly 14 and attached by the fasteners 16 affixing to both the fasteners 34 and fasteners 36. By this means the cover assembly 12 acts to reinforce the relative position between the frame 24 and extension 26 of the frame assembly 14.

A series of apertures 20 in the cover 18 are coordinated with the series of cleats 28 on the frame 24. When the cover assembly 12 is affixed to the frame assembly 14 the cleats 28 can then pass through the cover 18. The cleats 28 are used as attachment points for a harness assembly 46, described below. In the example in the drawings there are a series of three cleats 28 and corresponding apertures 20 shown. However, it should be appreciated that fewer or more cleats 28 with corresponding apertures 20 may be desirable or equally effective. Typically, anywhere from about one to ten cleats 28 and corresponding apertures 20 can be utilized.

The cover assembly 12 may be constructed of a washable material so that when soiled it can be readily cleaned in a washing machine. It may also be preferable in some circumstances that the cover assembly 12 not be removable from the frame assembly 14. For example, a neoprene based cover assembly 12 could be permanently adhered to the top surface of the frame assembly 14. This configuration would make the fasteners 16, 34 and 36 unnecessary. In other instances a cover assembly 12 may not be needed at all and yet the frame assembly and other components would remain fully functional.

Not shown in the figures is an alternate version of the frame assembly 14 where the frame 24 and/or the extension 26 are perforated with a series of holes that can function to lighten the weight of the device and may also aid in enhancing the airflow around the cover assembly 12 thereby allowing it to dry faster after use.

FIG. 3 is a bottom side perspective view of the device without the cover assembly 12 to reveal further elements of the device to include a pair of fasteners 34 and a pair of fasteners 36. The fasteners 16 on the cover assembly 12 adhere to the fasteners 34 and 36 to secure the cover assembly 12 to the frame assembly 14 and also to help secure the frame 24 relative to the extension 26 to fix the overall length of the frame assembly 14 during use or storage.

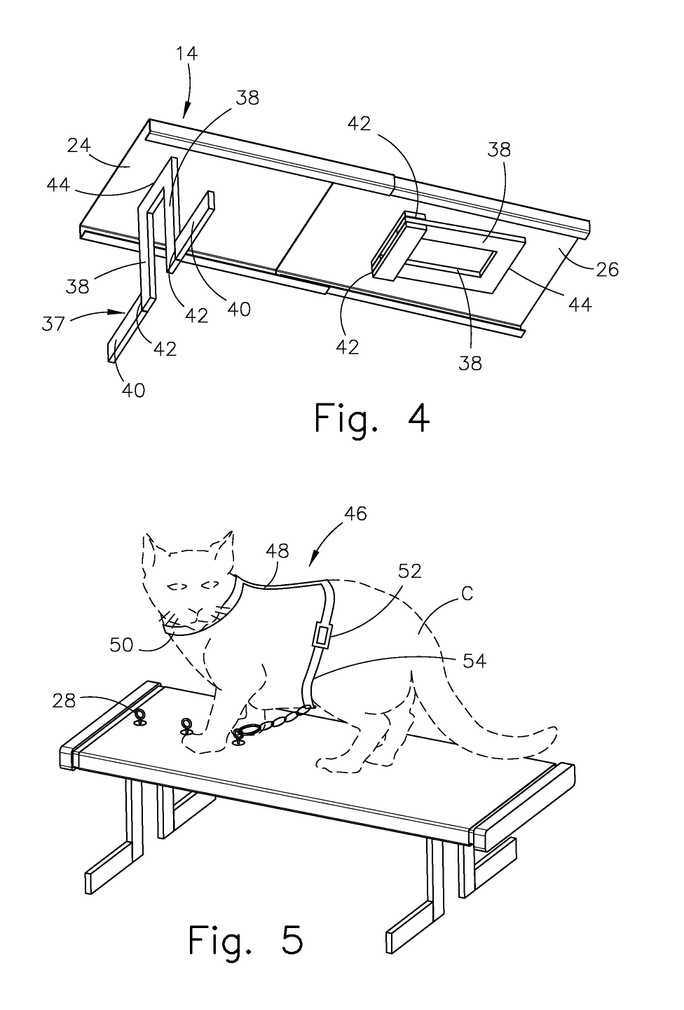

FIG. 4 shows an alternate version of the device to include a pair of support assemblies 37 on the bottom side of the frame assembly 14. The support assemblies 37 are comprised of legs 38, feet 40, hinges 42 and hinges 44. In this version the support assemblies 37 permit the device to be used over any suitable flat surface. In preparing the device for use, the legs 38 are folded about hinge 44 away from the bottom surface of the frame assembly 14 to substantially perpendicular and the feet 40 are extended outward laterally about hinge 42. The legs 38 determine the ultimate height of the frame assembly 14. The four laterally extending feet 40 provide stability during use.

Conversely, for storage or transport, the support assemblies 37 may be collapsed by folding in the feet 40 about hinges 42 and folding the legs 38 against the underside of the frame assembly 14 about hinge 44. There may also be a locking means to secure the support assemblies 37 in either the open or closed position. The feet 40 may have optional rubber-like shoes to prevent slippage of the device during use.

FIG. 5 shows and example of how the device might be configured for use washing a cat “C”. A harness assembly 46 is comprised of a strap 48, a yoke 50, a buckle 52, a yoke 54, a leash 56 and a clip 58. Generally, the yoke 54 is first gently secured around the abdomen of the cat with the buckle 54. Similar to a pet collar, the yoke 50 can then be gently fastened around the neck of the cat. The strap 48 connects the yoke 54 to the yoke 50 to prevent the cat from escaping the harness assembly 46.

On the ventral side of the front yoke 50 is the leash 56 that terminates at the clip 58. The clip 58 attaches the harness assembly 46, and thereby the cat, to the frame assembly 14 at any of the cleats 28. Generally, the shorter the leash 56 the better the device will work.

A preferred method of using the device to wash a cat requires the addition of a container of water such as a bath tub, a bucket, a small pool or other such container.

For example, the device as shown in FIG. 1 can be easily used with a bath tub by extending the frame assembly 14 to about the width of the tub and securing the cover assembly 12 over the frame assembly 14 to fix its length.

In other words, the invention can be fairly describes as an animal washing device comprising a frame assembly, a cover assembly and a harness assembly. The frame assembly is adapted to support the weight and size of a predetermined animal, such as a cat. The frame assembly preferably has one or more cleats on a first plane of said frame assembly. Most likely there are between one and ten cleats to easily facilitate many sizes of animal. The cover assembly is dimensioned to substantially cover and be affixed to said first plane of said frame assembly. Optionally, it is removable and washable and may be secured to the frame assembly with hook and loop fasteners, tape, string magnets or other means. In other versions the cover assembly is not needed. The harness assembly has a yoke and a leash where the yoke is configured to attach around the animal. The leash, on a first end, is releaseably connectable to said yoke and on a second end is releaseably connectable to any of said cleats, depending on the users preference and the size of the animal.

A variation of the animal washing device may further include that the frame assembly is supportable by a plurality of collapsible legs affixed to a second plane (bottom side) of said frame assembly.

Another option of the animal washing device may further characterized in that the frame assembly is extendable in a first dimension to expand the surface area of said first plane of said frame assembly so that the device can span a container of water (for example a tub, a bathtub, a shower, a bucket, a sink or a basin) or be supported by other objects (for example between to tables or chairs). Having some distance under the animal during washing tends to keep it in place and may also be more convenient to the user.

Preferably the cover assembly is separable from said frame assembly for washing and periodic replacement.

The invention can also be fairly directed toward a method for securing a feline (or other animal) for washing. The method utilizes a frame and a harness assembly where the frame is adapted to support the weight and size of a predetermined class of feline. Any size from a house cat to a lion is readily apparent. The frame has a first side onto which one or more cleats are affixed and the harness assembly is further comprised of a yoke and a leash. The yoke is adapted to, and secures around, said feline. The leash on a first end is affixed to said yoke then the feline is placed onto said first side of said frame (the top side) and then the leash on a second end is affixed to said cleat. This effectively restrains the feline on top of the board, preferably suspended over a container of water (for example, a tub, a bathtub, a shower, a bucket, a sink or a basin) or simply at a predetermined height off the ground. Then the feline can then be gently washed with a water solution or any other appropriate means.

Optionally, a cover assembly is included that is comprised of a soft material grippable by said feline and that substantially covers said first (top) side of the frame. This gives the feline something to grab onto thus increasing the feline's sense of security and reducing stress on the animal.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. An animal washing device comprising a frame assembly, a cover assembly and a harness assembly;
Said frame assembly adapted to support the weight and size of a predetermined animal;
Said frame assembly having one or more cleats on a first plane of said frame assembly;
Said cover assembly dimensioned to substantially cover and be affixed to said first plane of said frame assembly;
Said harness assembly further having a yoke and a leash;
Said yoke configured to attach around said animal;
Said leash on a first end releaseably connectable to said yoke and on a second end releaseably connectable to any of said cleats.

2. An animal washing device as disclosed in claim 1, further characterized in that said frame assembly is supportable by a plurality of collapsible legs affixed to a second plane of said frame assembly.

3. An animal washing device as disclosed in claim 1, further characterized in that said frame assembly is extendable in a first dimension to expand the surface area of said first plane of said frame assembly.

4. An animal washing device as disclosed in claim 1, further characterized in that said frame assembly is adapted to span over and be supported by a predetermined container selected from any of a tub, a bathtub, a shower, a bucket, a sink or a basin.

5. An animal washing device as disclosed in claim 3, further characterized in that said frame assembly is adapted to span over and be supported by a predetermined container selected from any of a tub, a bathtub, a shower, a bucket, a sink or a basin.

6. An animal washing device as disclosed in claim 1, further characterized in that said cover assembly is separable from said frame assembly.

7. An animal washing device comprising a frame assembly and a harness assembly;
Said frame assembly adapted to support the weight and size of a predetermined animal;
Said frame assembly having one or more cleats on a first plane of said frame assembly;
Said harness assembly further having a yoke and a leash;
Said yoke adapted to secure around said animal;
Said leash on a first end releaseably connectable to said yoke and on a second end releaseably connectable to any of said cleats.

8. An animal washing device as disclosed in claim 7, further including a cover assembly that is adapted to substantially cover and be affixed to said first plane of said frame assembly.

9. An animal washing device as disclosed in claim 7, further characterized in that said frame assembly is supportable by a plurality of collapsible legs affixed to a second plane of said frame assembly.

10. An animal washing device as disclosed in claim 7, further characterized in that said frame assembly is extendable in a first dimension to expand the surface area of said first plane of said frame assembly.

11. An animal washing device as disclosed in claim 10, further characterized in that said frame assembly is dimensioned to span over a predetermined container selected from any of a tub, a bathtub, a shower, a bucket, a sink or a basin.

12. A method for securing a feline for washing comprising a frame and a harness assembly;
Said frame is adapted to support the weight and size of a predetermined class of feline;
Said frame has a first side onto which one or more cleats are affixed;
Said harness assembly is further comprised of a yoke and a leash where said yoke is adapted to secure around said feline;
Said yoke is secured around said feline;
Said leash on a first end is affixed to said yoke;
Said feline is placed onto said first side of said frame;
Said leash on a second end is affixed to said cleat;
Said feline is gently washed.

13. A method for securing a feline for washing as disclosed in claim 12, further including a cover assembly that is comprised of a soft material grippable by said feline and that substantially covers said first side of said frame.

14. A method for securing a feline for washing as disclosed in claim 12, further characterized in that during said gentle wash said frame assembly is suspended over a predetermined container of water selected from any of a tub, a bathtub, a shower, a bucket, a sink or a basin.

15. A method for securing a feline for washing as disclosed in claim 13, further characterized in that during said gentle wash said frame assembly is suspended over a predetermined container of water selected from any of a tub, a bathtub, a shower, a bucket, a sink or a basin.
